(19) United States
(12) Patent Application Publication
(10) Pub. No.: US 2016/0154452 A1
(43) Pub. Date: Jun. 2, 2016

(54) SYSTEM AND METHOD FOR CONTROLLING THE POWER MODE OF OPERATION OF A MEMORY DEVICE

(71) Applicant: ARM LIMITED, Cambridge (GB)

(72) Inventors: Andreas HANSSON, Cambridge (GB); Ashley John CRAWFORD, Saffron Walden (GB); Michael Andrew CAMPBELL, Cambridge (GB); Stephan DIESTELHORST, Cambridge (GB)

(21) Appl. No.: 14/557,895

(22) Filed: Dec. 2, 2014

(51) Int. Cl. G06F 1/32; G06F 13/24; G06F 9/44

(52) U.S. Cl. CPC G06F 1/3287; G06F 9/4418; G06F 13/24

(57) ABSTRACT

A system and method are provided for controlling the power mode of operation of a memory device. The system includes a processing device for performing processing operations on data, and a memory controller associated with the memory device, the memory device being used to store data for access by the processing device. The memory controller has power mode control circuitry to switch the memory device between different power modes of operation. Further, an interrupt controller is configured to issue an event signal to the processing device to trigger performance of at least one processing operation. On issuing the event signal, the interrupt controller further initiates generation of a wakeup stimulus signal to the power mode control circuitry, and the power mode control circuitry is then arranged to determine whether to change the power mode of operation of the memory device in dependence on the wakeup stimulus signal. By such an approach, the wakeup stimulus signal can provide an early trigger to the power mode control circuitry to exit the memory device from at least one low power mode of operation in anticipation of the performance of the at least one processing operation by the processing device requiring data to be accessed in the memory device.

### BACKGROUND

The present technique relates to a system and method for controlling the power mode of operation of a memory device.

Power mode control functionality may be provided within the memory controller for a memory device, so as to enable the memory device to be placed into a number of different power modes of operation. This enables the power consumption of the memory device to be reduced, for example by enabling the memory device to be placed into a low power mode of operation during periods of inactivity.

Various techniques may be provided within the memory controller for deciding when to transition to particular power states, and hence by way of example the memory controller may be arranged to look at previous usage patterns in order to try and determine when to transition between different power states. With the ever increasing pressure on power consumption, it is desirable for the memory controller to place the memory device into low power modes of operation wherever possible. However, power mode transitions within a memory device take time, and accordingly the aggressive use of low power modes within the memory device can give rise to significant performance impacts, if a request for access to data in the memory device is received by the memory controller at a time when the memory device is in a low power mode of operation.

Accordingly, it would be desirable to provide a mechanism which would reduce the prospect of such a scenario occurring, so as to enable the power consumption benefits of using low power modes of operation in respect of a memory device to be retained, but whilst reducing the potential performance impact of such an approach.

### SUMMARY

In one example arrangement there is provided a system comprising: a processing device to perform processing operations on data; a memory controller for a memory device used to store data for access by the processing device, the memory controller having power mode control circuitry to switch the memory device between different power modes of operation; and an interrupt controller to issue an event signal to the processing device to trigger performance of at least one processing operation; the interrupt controller further being arranged on issuing the event signal to initiate generation of a wakeup stimulus signal to the power mode control circuitry, the power mode control circuitry being arranged to determine whether to change the power mode of operation of the memory device in dependence on the wakeup stimulus signal.

In a second example arrangement there is provided an interrupt controller comprising: event signal generation circuitry to issue an event signal to a processing device to trigger performance of at least one processing operation; and wakeup stimulus generation circuitry to generate a wakeup stimulus signal to power mode control circuitry of a memory controller on issuance of the event signal, for reference by the power mode control circuitry to determine whether to change the power mode of operation of an associated memory device.

In a third example arrangement, there is provided a memory controller comprising: an interface to a memory device used to store data for access by a processing device; and power mode control circuitry to switch the memory device between different power modes of operation; the power mode control circuitry being responsive to a wakeup stimulus signal triggered by an interrupt controller's issuance of an event signal to the processing device, to determine whether to change the power mode of operation of the memory device.

In a further example arrangement, this is provided a method of controlling a power mode of operation of a memory device, comprising: employing power mode control circuitry, within a memory controller for the memory device, to switch the memory device between different power modes of operation; issuing an event signal from an interrupt controller to a processing device to trigger performance of at least one processing operation by the processing device; employing the interrupt controller, on issuing the event signal, to initiate generation of a wakeup stimulus signal to the power mode control circuitry; and within the power mode control circuitry, determining whether to change the power mode of operation of the memory device in dependence on the wakeup stimulus signal.

In a yet further example arrangement there is provided a system comprising: processing means for performing processing operations on data; memory control means for a memory device used to store data for access by the processing means, the memory control means having power mode control means for switching the memory device between different power modes of operation; and interrupt control means for issuing an event signal to the processing means to trigger performance of at least one processing operation; the interrupt control means, on issuing the event signal, for initiating generation of a wakeup stimulus signal to the power mode control means, the power mode control means for determining whether to change the power mode of operation of the memory device in dependence on the wakeup stimulus signal.

### BRIEF DESCRIPTION OF THE DRAWINGS

The present technique will be described further, by way of example only, with reference to embodiments thereof as illustrated in the accompanying drawings, in which:

FIG. 1 is a block diagram of a system in accordance with a first embodiment;

FIG. 2 is a block diagram of a system in accordance with an alternative embodiment;

FIG. 3 illustrates how the memory controller may utilise the wakeup stimulus in accordance with one embodiment;

FIG. 4 illustrates how the memory controller may utilise the wakeup stimulus in accordance with an alternative embodiment;

FIG. 5 is a flow diagram illustrating the operation of the stimulus generator circuitry of FIG. 2 in accordance with one embodiment;

FIGS. 6A and 6B are flow diagrams illustrating the operation of power mode control circuitry within the memory controller in accordance with one embodiment;

FIG. 7 schematically illustrates different power modes of operation, in accordance with one embodiment;

FIG. 8 illustrates how the wakeup stimulus may be used within the memory controller in accordance with an alternative embodiment; and

FIG. 9 is a block diagram of a system in accordance with a yet further embodiment.

### DESCRIPTION OF EMBODIMENTS

Before discussing certain embodiments with reference to the accompanying figures, the following description of embodiments is provided.

In accordance with one example embodiment, a system includes a processing device for performing processing operations on data, and a memory controller for controlling a memory device that is used to store data for access by the processing device. The memory controller has power mode control circuitry to switch the memory device between different power modes of operation. Further, an interrupt controller is arranged to issue an event signal to the processing device in order to trigger performance of at least one processing operation.

In addition to issuing the event signal, the interrupt controller initiates generation of a wakeup stimulus signal to the power mode control circuitry of the memory controller. The power mode control circuitry then determines whether to change the power mode of operation of the memory device in dependence on the wakeup stimulus signal.

Whilst the issuance of the event signal from the interrupt controller may not directly indicate that any access to data in the memory device will be necessary by the processing device (since that will depend on a number of factors, such as the at least one processing operation that is triggered within the processing device in response to that event signal, whether any data that is required by the processing device is present in a cache within the system, etc), it does provide a very early indication of a potential need for an access to the memory device. Accordingly, by arranging the interrupt controller to initiate the generation of such a wakeup stimulus signal, the power mode control circuitry can be provided with an early flag that an access may be needed in due course, and can take that information into account when determining the appropriate power mode of operation for the memory device at that point in time. This early indication can be very useful, since as mentioned earlier it can take a significant time to transition the memory device from one power mode of operation to another, and in certain low power modes it can take significantly longer to exit those low power modes than to enter them. Accordingly, such an early indication of the potential need for an access can significantly improve system performance, by enabling the memory controller to have placed the memory device into the appropriate power mode prior to an access request for data being received.

There are a number of ways in which the power mode control circuitry may utilise the wakeup stimulus signal. In one embodiment, the power mode control circuitry is responsive to the wakeup stimulus signal to transition the memory device from a first power mode of operation to a second power mode of operation, where the second power mode of operation consumes more power than the first mode of operation, in anticipation of the performance of said at least one processing operation by the processing device requiring data to be accessed in the memory device.

Accordingly, in such an embodiment the wakeup stimulus signal is directly used to trigger the exit of the memory device from a lower power mode operation into a less low power mode of operation. Such a transition can be initiated immediately upon receipt of the wakeup stimulus signal, or may be delayed for a certain period of time, for example if the memory controller has knowledge of the time that will be taken to transition from the first power mode to the second power mode, and some knowledge of a minimum latency that can be expected between receipt of the wakeup stimulus signal and any access request from the processing unit subsequently being received by the memory controller.

In the above embodiment, the power mode control circuitry reacts directly to the wakeup stimulus signal to transition the memory device, and does not seek to make any analysis as to the likelihood that an access request will be needed. Accordingly, such an approach has the performance benefit that it will take active steps to bring the memory device out of a low power mode of operation in anticipation of a data access being required. It is often the case that at least one data access to the memory device will be needed to enable the processing device to perform the processing operation or processing operations triggered by the event signal, and hence this can be a suitable approach to take in those situations. However, as will be discussed in more detail later, in other embodiments, for example in situations where there is considered a reasonable likelihood that a memory access may not be required, the power mode control circuitry can be arranged to perform further analysis before deciding what action to take in response to the wakeup stimulus signal, thereby reducing the prospect of exiting a low power mode unnecessarily.

In one embodiment, the interrupt controller generates the wakeup stimulus signal directly from the event signal. Typically an interrupt controller will send out such an event signal to a processing unit on some form of an event bus, for example an nIRQOUT or an nFIQOUT event bus. In one particular embodiment, the memory controller could also be connected directly to such an event bus, so that the wakeup stimulus signal is actually formed directly by the event signal.

However, in an alternative embodiment, the wakeup stimulus signal can be generated in response to the event signal, but take the form of a physically separate signal. In particular, in one embodiment, the system further comprises stimulus generation circuitry responsive to an indication of issuance of the event signal to generate the wakeup stimulus signal with reference to control data.

The control data can take a variety of forms, but in one embodiment comprises filter data used to identify for which types of event signal the wakeup stimulus signal is to be generated. Hence, in such embodiments, it may be decided that there are certain types of event signal which are more likely to cause the processing unit to initiate processing operations that require access to data in the memory, and to limit the generation of the wakeup stimulus signal to such event types. As will be understood, there are potentially many different sources of event input to the interrupt controller, for example timers, various network interrupt sources, etc. The interrupt controller may be configured so that for certain types of event signals sent to the processing unit, for example event signals in response to one or more of the timers, no wakeup stimulus signal should be issued to the memory controller. This can be used to reduce the extent to which the memory device is exited from a low power state unnecessarily, whilst still allowing an early trigger of such a low power state exit for certain types of events, hence improving system performance when processing such events.

In an alternative embodiment, or in addition, the control data may comprise hint data to be provided with the wakeup stimulus signal for reference by the power mode control circuitry when determining whether to change the power mode of operation of the memory device in dependence on the wakeup stimulus signal. Such hint data may be analysed by the power control circuitry within the memory controller when deciding how and/or when to respond to the wakeup stimulus signal.

For example, the hint data may comprise at least one of likelihood data indicative of a likelihood that the performance of said at least one processing operation by the processing device will require data to be accessed in the memory device, and urgency data indicating an urgency with which said at least one processing operation needs to be performed by the processing device. The power control circuitry within the memory controller can then use this information, potentially in combination with other information accessible to the memory controller, such as for example the energy cost associated with particular power mode transitions and the timing associated with particular power mode transitions, in order to determine what steps to take in response to the wakeup stimulus signal.

For example, the likelihood data may be used to determine whether a power mode transition is warranted. In one embodiment, this decision may depend on the current power mode that the memory device is in. In particular, in some embodiments there may be multiple different power saving modes, allowing various granularities of power saving to be achieved, for example by successively placing more and more components of the memory device in a power saving state as each additional power saving mode is entered. Often, the more components of the memory device that are placed into a low power mode, the longer it takes to exit from that low power mode. There will also be different energy costs associated with transitions between the different modes. This information can be taken into account, along with information such as the likelihood data and/or the urgency data in order to decide if a transition in power mode is warranted, and whether action should be taken immediately or at some future time.

In one embodiment, control storage is provided for storing the control data, and the processing device has access to the control storage in order to write the control data into the control storage. Hence, in such an embodiment, the control data is programmable by the processing device, with the control storage providing an architecturally visible mechanism for the processing unit to encode and control which type of events should trigger generation of the wakeup stimulus signal to the memory controller, and any forms of hint data that should be provided. Often, the processing device will itself have entered a lower power mode whilst waiting for the event signal from the interrupt controller, and accordingly by such a mechanism software running on the processing device, such as the operating system, would be able to specify via the control data, before entering its lower power mode, whether it is appropriate for the fast proactive wakeup mechanism embodied by the wakeup stimulus signal to be used or not, and in response to which event types.

The stimulus generation circuitry may be provided at a variety of locations within the system, but in one embodiment it is provided within the interrupt controller itself. However, in an alternative embodiment the stimulus generation circuitry could be provided within the memory controller, for example with all events from the interrupt controller being forwarded to the stimulus generation circuitry, and with the stimulus generation circuitry then determining for which events to issue wakeup stimuli to the power mode control circuitry of the memory controller.

As mentioned earlier, there are a number of ways in which the power mode control circuitry may respond to the wakeup stimulus signal. In one embodiment, the power mode control circuitry is responsive to the wakeup stimulus signal to determine a current power mode of operation of the memory device, and if that current power mode of operation is not the highest power mode of operation, to determine a higher power mode of operation to which the memory device is to be transitioned to in dependence on the wakeup stimulus signal.

Further, in one embodiment, the power mode control circuitry is arranged to reference power mode transition reference data to determine whether the wakeup stimulus signal warrants the transitioning of the memory device from its current power mode of operation to said higher power mode of operation. In particular, the memory controller will often store such reference data for general use when deciding how to transition between the various power modes, and accordingly that information can also be referenced when determining how to respond to the wakeup stimulus signal.

In one particular example, the power mode transition reference data comprises energy cost data indicative of the energy consumed in transitioning the memory device from its current power mode of operation to said higher power mode of operation. Hence, purely by way of example, in some situations, such as for example where the earlier-mentioned hint data indicates that the likelihood of a subsequent access is relatively low, the power mode control circuitry may determine that the energy consumption cost associated with the transition is high enough to make the transition not warranted, given the current likelihood of an access being required.

In an alternative embodiment, or in addition, the power mode control circuitry may be arranged to reference the power mode transition reference data to determine timing for transition of the memory device from its current power mode of operation to said higher power mode of operation.

For example, the power mode transition reference data may comprise timing data indicative of the time required to transition the memory device from its current power mode of operation to said higher power mode of operation. If the time taken to transition is relatively large, the power mode control circuitry may decide to initiate the transition immediately. However, if the time required to transition is relatively short having regard to the current power mode and the power mode to be transitioned to, it may be possible to defer the initiation of that transition for some period of time, for example if the memory controller has some knowledge about the expected latency between arrival of the wakeup stimulus and any future access request arriving at the memory controller.

In particular, in one embodiment, the power mode control circuitry is arranged to further reference latency data indicative of a time delay between issuance of said event signal and an access being required to said memory device in response to performance of said at least one processing operation by the processing device. Such latency data may be pre-programmed into the memory controller, or may be modified adaptively, for example based on the memory controller monitoring previous history of accesses.

As mentioned earlier, the power mode control circuitry may also be arranged to reference hint data provided with the wakeup stimulus signal to determine whether the wakeup stimulus signal warrants the transitioning of the memory device from its current power mode of operation to said higher power mode of operation.

In a further embodiment, the power mode control circuitry may be arranged to reference a history of wakeup stimulus signals to determine whether a current wakeup stimulus signal warrants the transitioning of the memory device from its current power mode of operation to said higher power mode of operation. Accordingly, by way of example, if the hint data associated with a current wakeup stimulus signal is determined in itself not to warrant a transition of the memory device from its current power mode of operation, the power mode control circuitry may be arranged to look at the preceding history of wakeup stimulus signals, and to then re-evaluate its decision based on that history.

There are a number of situations where a reference to such a history of wakeup stimulus signals might be useful. In one particular example arrangement, the processing device may be coupled to the memory controller via a cache hierarchy comprising one or more levels of cache, and at least one level of cache within the cache hierarchy is arranged to issue a supplemental wakeup stimulus signal to the memory controller on occurrence of a predetermined event.

The predetermined event can take a variety of forms, but in one embodiment may comprise a cache miss arising in said at least one level of cache for data required by the at least one processing operation performed by the processing device. Hence, it may be the case that an original wakeup stimulus signal triggered from the interrupt controller includes hint data that was determined not to warrant the transitioning of the memory device from its current power mode of operation to a higher power mode of operation. However, one or more subsequent supplemental wakeup stimulus signals may effectively serve to increase that likelihood of an access being required, when considered in combination with the earlier wakeup stimulus signal history, and accordingly at some point may trigger the power control circuitry to respond by transitioning the power mode to a less power saving mode.

Particular embodiments will now be described with reference to the figures.

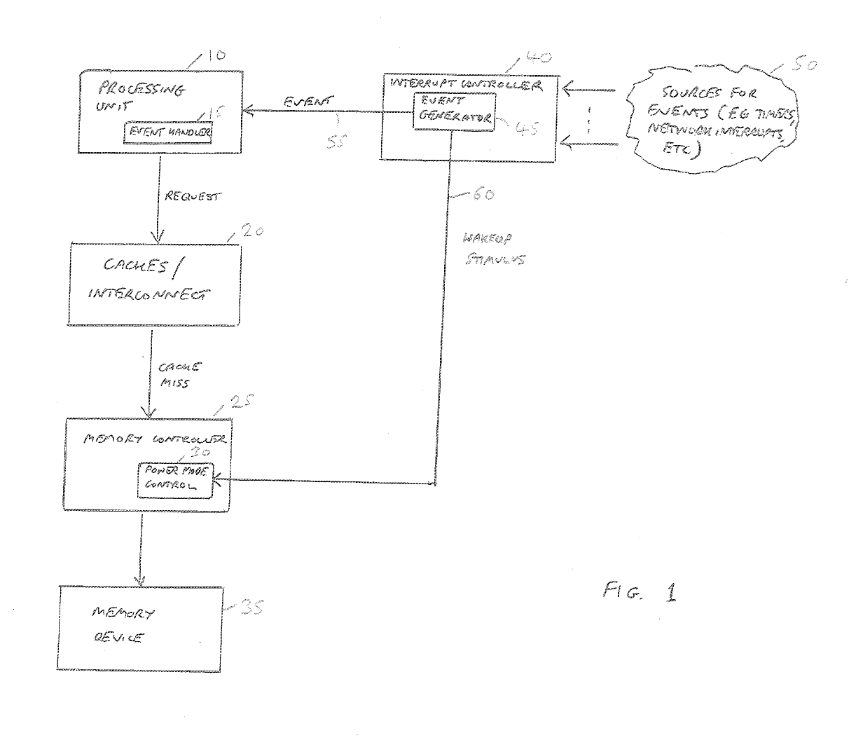

FIG. 1 is a block diagram of a system in accordance with one embodiment. A processing unit 10 is coupled via one or more levels of cache and/or an interconnect structure 20 with a memory controller 25 used to control accesses to a memory device 35. The memory controller 25 has power mode control circuitry 30 used to switch the memory device between a number of power modes of operation in order to seek to reduce the overall power consumption of the memory device. Typically, in addition to a fully on power mode, there will be a number of different lower power modes of operation, with various different components of the memory device being placed in a lower powered state dependent on the particular lower power mode selected. Whilst this can give rise to significant power saving benefits, the transitions between the various power modes can take a significant amount of time, and this can give rise to a performance impact when considering the time taken to exit a low power mode. For example, the processing unit 10 will perform a series of data processing operations on data, and accordingly the processing unit will typically output requests for data required to the caches/interconnect structures 20. If the data resides within one or more of the caches, then the access request from the processing unit may be able to be serviced without any need for access to the memory device. However, in the event that the data required is not within the caches, then a cache miss signal will be generated which essentially takes the form of an access request to the memory controller seeking to access the required data within the memory device 35. If at the time the access request is received by the memory controller 25, the memory device 35 is in a low power mode of operation, it will typically not be able to process the access request until the memory device has exited that low power mode. This can give rise to a significant latency in processing the access request from the processing unit, and this will often impact on the performance of the processing unit. Accordingly, whilst it is highly desirable to use the low power modes of operation of the memory device wherever possible in order to improve the overall power consumption characteristics of the system, it is desirable for the memory device to have exited those low power modes by the time an access request needs to be serviced.

The processing unit 10 can take a variety of forms, for example a central processing unit (CPU), a graphics processing unit (GPU), or any other master device used to perform processing operations on data that may be held in the memory. Typically there will be an interrupt controller 40 associated with the processing unit that monitors various event sources 50 within the system. On occurrence of certain events, an event generator 45 within the interrupt controller 40 will trigger an event signal over path 55 to the processing unit 10, to cause the processing unit to initiate performance of one or more processing operations. Whilst the generation of such an event in itself may not provide any direct indication that the processing unit 10 will need to access data in the memory device, in the embodiment illustrated in FIG. 1 the event generator 45 also generates a wakeup stimulus signal over path 60 to the power mode control circuitry 30 when it issues an event signal over path 55 to the processing unit 10. This can be used to provide a very early indication to the memory controller than an access may in due course be required, and accordingly can provide an early trigger for causing the power mode control circuitry 30 to exit the memory device 35 from one or more low power modes of operation.

The events issued over path 55 can take a variety of forms, but in one embodiment take the form of an interrupt signal that causes an event handler 15 to perform execution of an exception routine in order to process the interrupt signalled by the event. The processing unit 10 may need to temporarily stall the execution of what it is doing in order to handle the exception routine, or alternatively the processing unit 10 may effectively be in an idle state waiting for the event to be received. For example, the processing unit can be arranged to use wait for event or wait for interrupt procedures to enter a lower power state itself whilst waiting for the event from the interrupt controller. Upon receipt of the event from the interrupt controller the processing unit then wakes up from its lower power state and begins to perform certain processing operations to process the event.

The power mode control within the memory controller 25 may operate independently from the processing unit, but often the power mode control circuitry 30 will seek to identify idle periods in which the memory device can be placed into a low power mode. When using such wait for event or wait for interrupt type processing, there can be significant idle processing periods where the processing unit is not issuing any access requests, and accordingly the memory controller's power mode control circuitry is likely to place the memory device into a low power mode during such periods of time. By generating a wakeup stimulus directly from generation of the event signal to the processing unit, this can cause the power mode control circuitry 30 to begin exiting the memory device from the low power mode of operation in anticipation of the processing unit then issuing an access request after it has woken up and began to perform the required event handling routines.

However, the use of the wakeup stimulus signal is not limited to situations where the processing unit is using such wait for event or wait for interrupt techniques, and may also be usefully employed for a variety of other different types of events that may be issued from the interrupt controller to the processing unit.

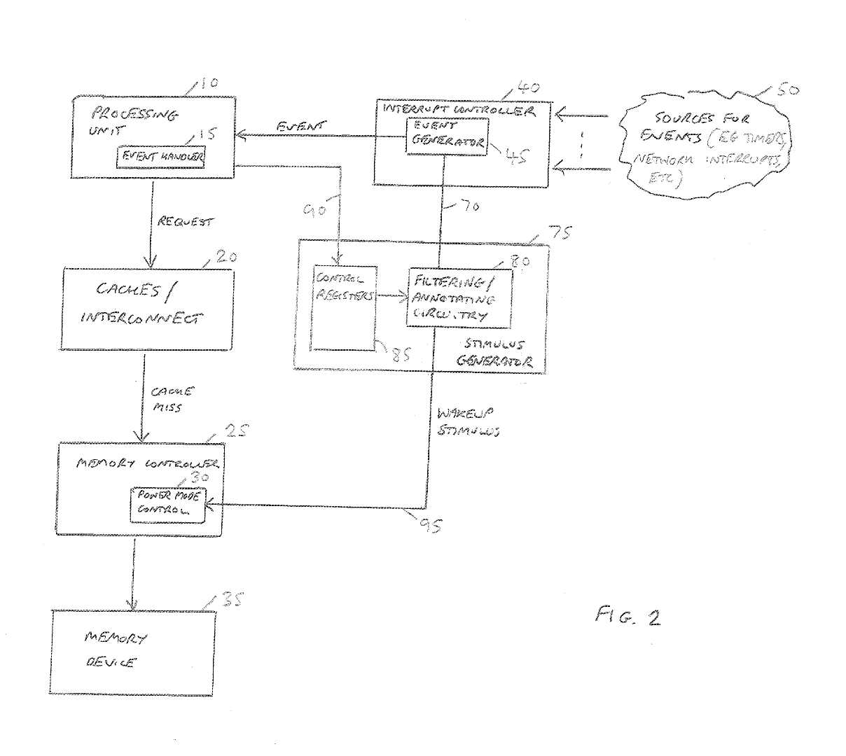

In the embodiment shown in FIG. 1, it is assumed that the wakeup stimulus signal is issued directly by the event generator upon issuance of each event over path 55 to the processing unit 10. However, in an alternative embodiment as shown in FIG. 2, stimulus generator circuitry 75 may be provided for determining when to generate a wakeup stimulus signal in response to an event being generated by the interrupt controller 40. In particular, in this embodiment, each time an event is generated by an event generator 45, it sends a signal over path 70 to filter/annotating circuitry 80 within the stimulus generator circuitry 75. The filtering/annotating circuitry 80 has access to control data stored in control registers 85 that is referenced to determine if a wakeup stimulus signal should be generated, and whether any additional information should be provided in association with that wakeup stimulus signal.

In one embodiment, the control data can provide filter data that is used to identify for which types of event signal the wakeup stimulus signal is to be generated. For example, it may be determined that, for only a subset of the potential events generated by the sources 50, should a wakeup stimulus signal actually be generated to the memory controller 25. Effectively this information can be used to filter out any events that are unlikely to cause the processing unit to then perform processing operations that require access to data in the memory. Such information may be pre-programmed into the control registers 85, or alternatively the control registers can be provided as an architecturally visible mechanism to the processing unit 10 to enable the processing unit to encode and control which events should trigger the wakeup stimulus signal to the memory controller 25.

The control data can also provide other forms of information, either in addition to the filter data, or instead of the filter data. For example, the control data may comprise hint data that can then be added by the filtering/annotating circuitry 80 to the wakeup stimulus signal to provide certain additional information to the power mode control circuitry 30. For example, such hint data may include likelihood data indicative of the likelihood that the processing operations performed by the processing unit in response to the associated event will cause at least one access to the memory to be required. Alternatively, or in addition, the hint data may provide urgency data indicating an urgency with which the processing operations to be performed by the processing unit need to be performed. The power mode control circuitry can then use this additional information provided with the wakeup stimulus signal in order to decide how to react to the wakeup stimulus signal. For example, in some embodiments it may decide that, having regards to the current power mode of the memory device, no change in the power mode is warranted. Alternatively, it may decide that a change is warranted, but that initiation of that change can be deferred for a certain period of time. More details of the operation of the power mode control circuitry in response to the wakeup stimulus signal will be provided with reference to the subsequent figures.

Whilst in FIG. 2 the stimulus generator 75 is shown as a separate component, it can be provided at a number of different locations within the system. Whilst it can indeed be a standalone component, in one embodiment it can be incorporated within the interrupt controller 40. This makes application of the filtering operations more straightforward, since the interrupt controller already has information about the types of events that it is receiving from the sources 50. However, in an alternative embodiment, the stimulus generator functionality could be incorporated within the memory controller 25, with the information passed from the event generator 45 to the stimulus generator 75 including information about the type of event that has been generated, so as to enable the filtering/annotating circuitry 80 to take appropriate steps with reference to the control data in the control registers 85. This will then result in the generation of a local wakeup stimulus internally within the memory controller for provision to the power mode control circuitry.

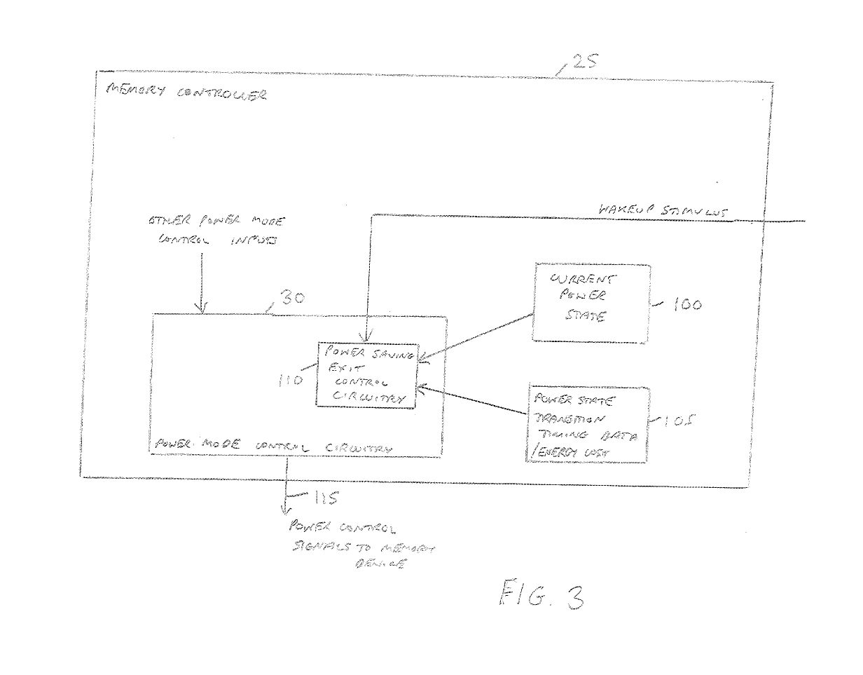

FIG. 3 illustrates the operation of the memory controller in response to the wakeup stimulus signal in accordance with one embodiment. In particular, the power mode control circuitry 30 will be responsive to various power mode control input signals to decide what power control signals to issue to the memory device over path 115. For example, it may analyse the history of transactions in order to determine suitable periods of time in which the memory device can be placed into low power modes, and similarly to determine when it is appropriate to begin transitioning the memory device out of those low power modes. The wakeup stimulus signal of one embodiment is used directly by power saving exit control circuitry 110 within the power mode control circuitry 30 to further influence decisions made about when to exit power saving modes of operation. The power saving exit control circuitry 110 also has information about the current power state (typically stored in an internal storage 100), and will further often be provided with power state transition reference data, such as timing data identifying the time typically associated with power mode transitions in either direction (i.e. from higher to lower power, or from lower to higher power), and the energy cost associated with power mode transitions in either direction. Often it is the case that the timing and energy costs are not symmetrical, in that it may take longer, and/or consumes more energy to exit from a low power mode to a less low power mode than the time taken and/or energy consumed in entering that low power mode from the less low power mode.

In one embodiment, the power saving exit control circuitry 110 may merely be arranged to directly respond to the wakeup stimulus signal by initiating transition of the memory device from its current power mode (assuming that is a low power mode) into a less low power mode. That less low power mode may be the immediately adjacent less low power mode or may be the fully on power mode. The power saving exit control circuitry 110 may trigger that transition immediately, or may make reference to the timing data 105 and/or some predetermined information that it has about the latency expected between the receipt of the wakeup stimulus and a first possible access from the processing unit in response to the event handling processing, to determine a suitable time at which to initiate the transition.

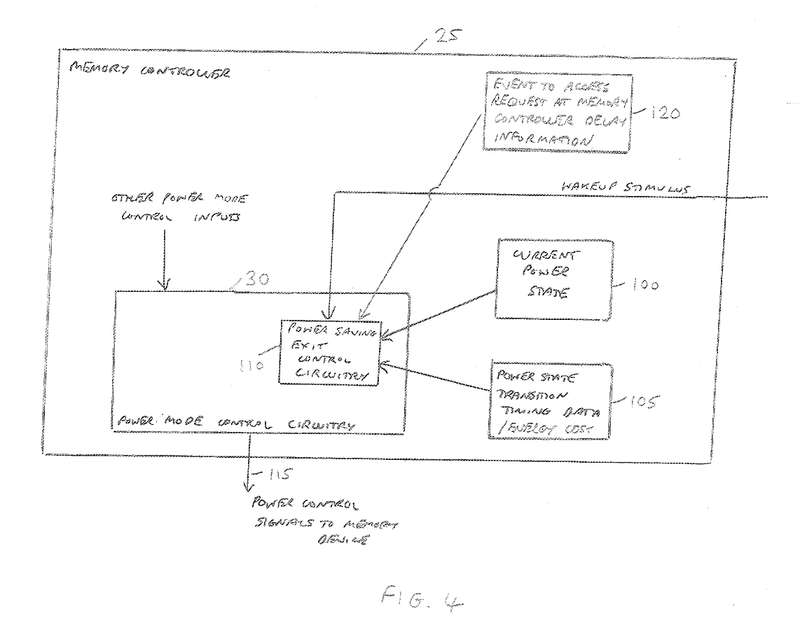

Such an arrangement is shown in FIG. 4, where the memory controller also maintains storage 120 providing delay information indicative of the delay between the event being received by the processing unit and an access request subsequently being received at the memory controller in response to the event handling processing performed by the processing unit. This information can be pre-programmed into the memory controller based on some minimum latency data that has been predetermined, or instead the information may be adaptive over time, for example by the memory controller monitoring previous history to build up a statistical indication of the delay between the wakeup stimulus being received and the first access from the processing unit subsequently arriving.

In an alternative embodiment, such latency data as held within the storage 120 could instead be maintained within the stimulus generator 75, with that latency data being provided as part of the wakeup stimulus signal itself.

Considering both of the embodiments of FIGS. 3 and 4, the energy cost information can also be used by the power saving exit control circuitry 110 to determine whether a particular transition is warranted having regards to the information provided in the wakeup stimulus signal. For example, where the wakeup stimulus signal provides hint data indicative of the likelihood of an access subsequently be received an/or the urgency of the operations being performed by the processing unit, it can take that information into account, in combination with the energy cost associated with a transition in power mode, in order to determine whether the power mode transition should be performed. It could also use that information to decide what transition should take place. For example, if the current power mode is a low power mode, there will typically be a number of options as to which power mode the memory device can be transitioned to. For example, it could merely be transitioned to the next adjacent, less low power, mode, or could be fully transitioned back up to the fully powered mode. Hence, a decision as to the destination power mode could also be influenced by the hint data in the wakeup stimulus signal and the energy cost information in the storage 105.

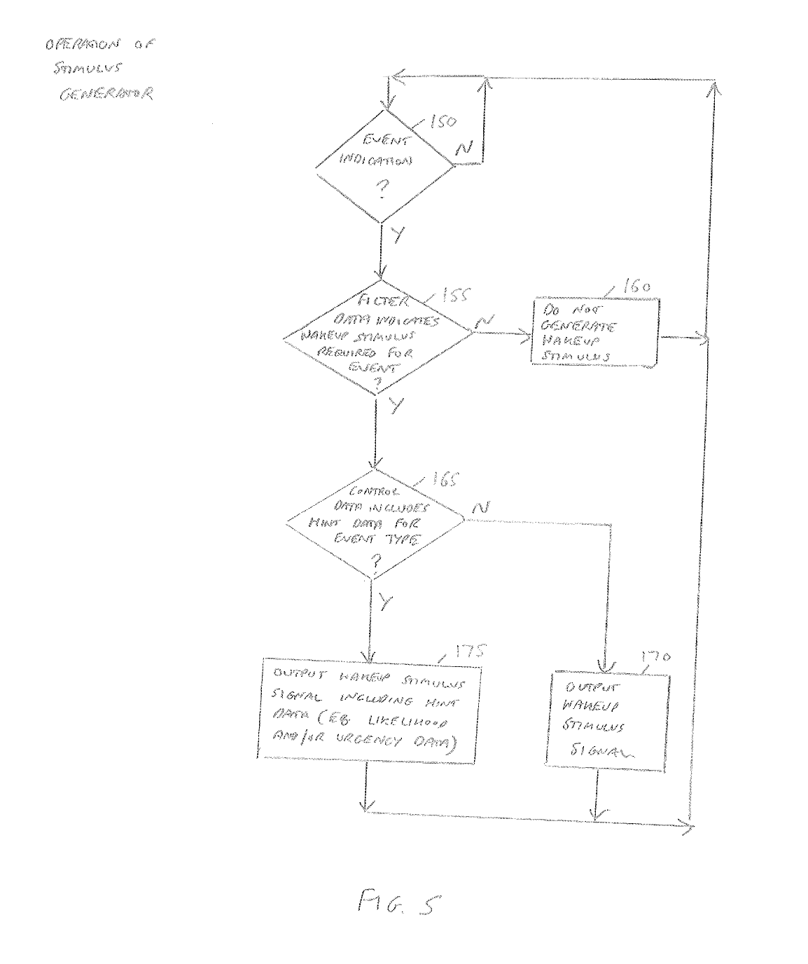

FIG. 5 is a flow diagram illustrating the operation of the stimulus generator 75 of FIG. 2 in accordance with one embodiment. At step 150, it is determined whether an event indication has been received over path 70 from the interrupt controller 40. If so, then at step 155 it is determined whether the filter data held within the control registers indicates that a wakeup stimulus is required for this particular event. If not, then no wakeup stimulus is generated at step 160, and instead the process returns to step 150 to await receipt of the next event indication.

However, assuming the filter data indicates that a wakeup stimulus signal should be generated, then the processing proceeds to step 165 where it is determined whether the control data includes any hint data for the event type. If not, then the wakeup stimulus signal is merely generated at step 170 without any associated hint data. However, if hint data is provided, then the annotating circuitry within the filtering/annotating circuitry 80 will incorporate that hint data with the wakeup stimulus signal that is generated, and hence the output wakeup stimulus signal will include such hint data, for example the earlier-mentioned likelihood data and/or urgency data. Following steps 170 or 175, the process then returns to step 150.

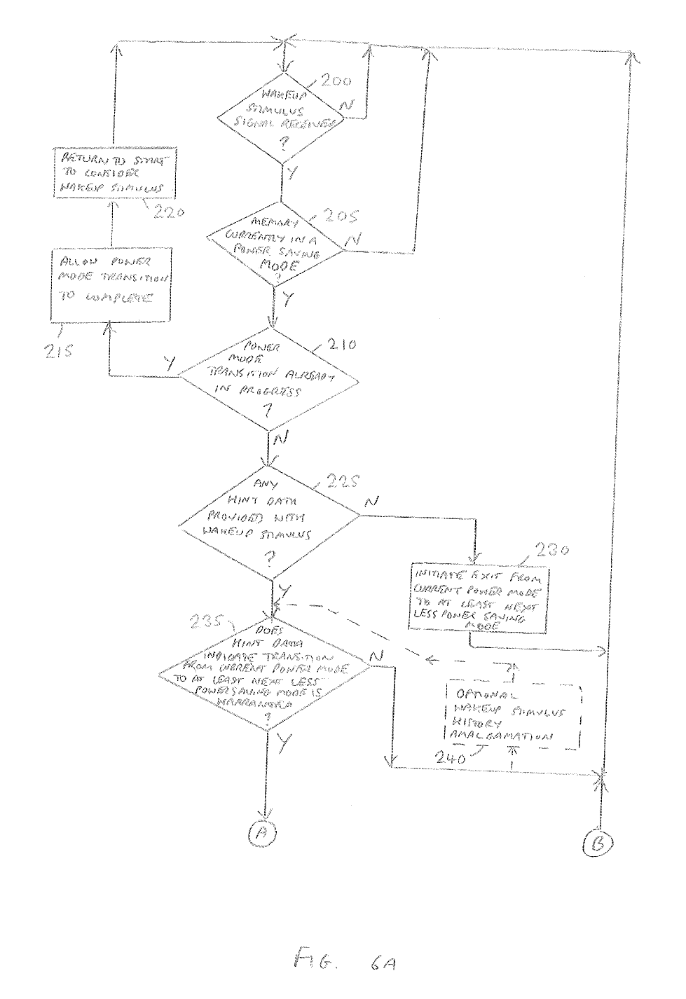

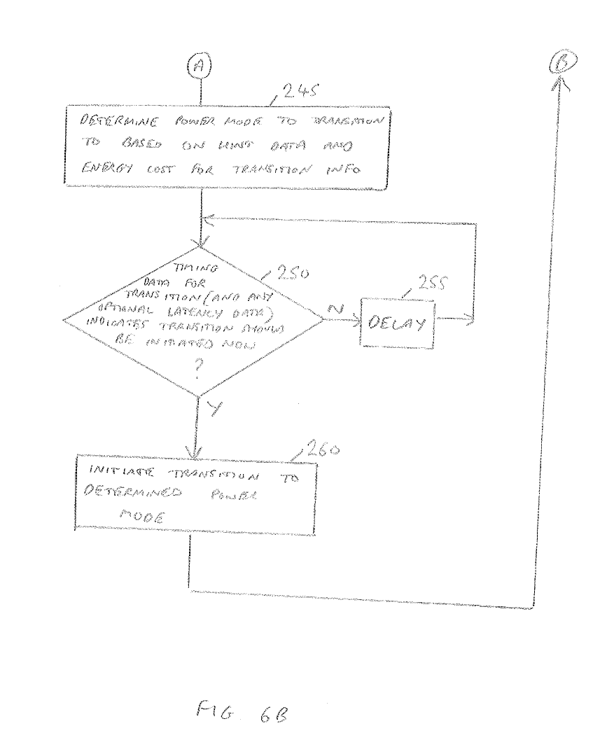

FIGS. 6A and 6B illustrate the operation of the power mode control circuitry 30 within the memory controller 25 in accordance with one embodiment. In particular, the flow diagram illustrates how the power mode control circuitry responds to receipt of a wakeup stimulus signal. At step 200 it is determined whether a wakeup stimulus signal has been received. If it has, then at step 205 it is determined whether the memory is currently in a power saving mode. If it is not, no action is required, and the processing merely returns to step 200. Assuming the memory is currently in a power saving mode it is then determined at step 210 whether a power mode transition is already in progress. As mentioned earlier, the power mode control circuitry 30 will typically receive a variety of power mode control inputs and will be taking decision at various points in time as whether to enter lower power modes of operation or whether to exit lower power modes of operation. Power mode transitions typically take a significant period of time, and hence there is a potential that a wakeup stimulus signal will be received whilst a power mode transition is in progress.

In the embodiment shown in FIG. 6A, in the event of that situation arising, then at step 215 the power mode transition is allowed to complete, whereafter at step 220 the process returns to the start to consider again the wakeup stimulus signal. Hence, in that scenario any wakeup stimulus signals occurring whilst a transition is taking place are effectively buffered and reconsidered once the current transition has completed.

Assuming it is determined at step 210 that a power mode transition is not currently in progress, then at step 225 it is determined whether there is any hint data provided with the wakeup stimulus signal. If not, then in one embodiment the power mode control circuitry 30 is merely arranged to respond to the wakeup stimulus signal by initiating exit from the current power mode to at least the next less power saving mode at step 230. As already discussed with reference to FIGS. 3 and 4, there are a variety of ways in which the power mode control circuitry may determine the most appropriate power mode to transition to. The process then returns to step 200.

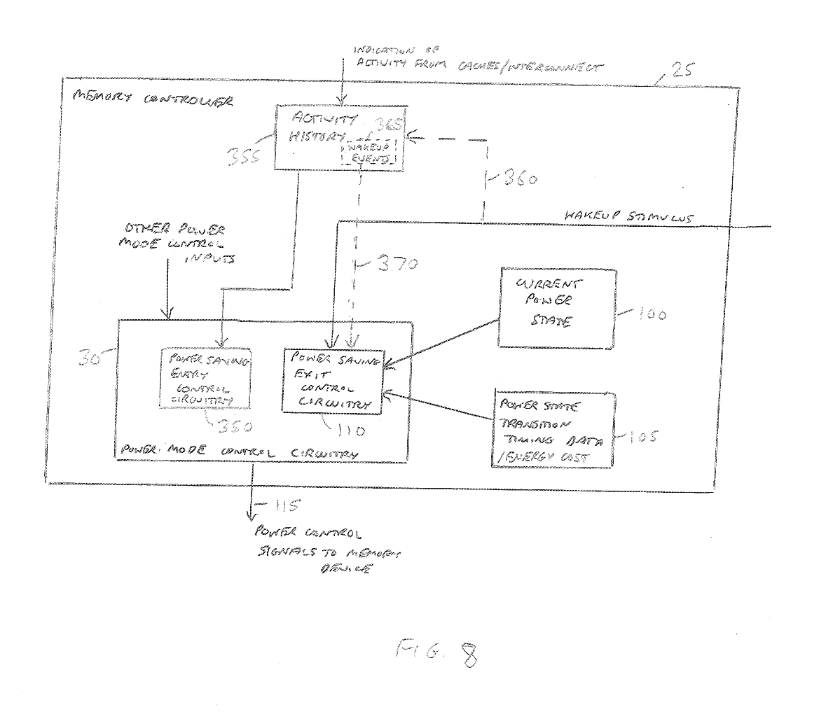

If hint data is provided with the wakeup stimulus signal then at step 235 it is determined whether that hint data indicates that a transition from the current power mode to at least the next less power saving mode is warranted. As previously mentioned, the hint data can be considered in combination with the timing data and/or energy cost data associated with power mode transitions in order to make that determination. If it is determined that a transition in power mode is not warranted, then in one embodiment the process merely returns to step 200. However, in an optional alternative embodiment as will be discussed later with reference to FIG. 8, the power saving exit control circuitry may at that point consider the preceding wakeup stimulus history (see step 240), and perform some amalgamation of that information in order to then consider at step 235 whether overall the hint data provided by that history indicates that transition from the current power mode should take place. If it does not, then the processing will then return to step 200. However, if at step 235 it is determined that a transition in power mode is warranted, then at step 245 the actual power mode to transition to is determined based on the hint data and the energy cost information for the transition such as available in the storage 105 of the memory controller 25.

Thereafter, at step 250 the timing data for the transition, and optionally any latency data provided in relation to the timing expected between the wakeup stimulus signal and an actual access request being received by the memory controller from the processing unit, are used to determine whether a transition should be initiated straight away. If not, a delay is introduced at step 255 and then step 250 is re-evaluated. Such an approach enables the power saving benefits to be maximised, in situations where it is known that the time taken to transition from the low power mode is less than the minimum latency expected with regards to an access being received from the processing unit. In one embodiment, any urgency indication provided as part of the hint data could also be taken into account at this point. For example, for urgent processing tasks, the power saving exit control circuitry could be arranged to initiate the power mode transition slightly earlier than it might otherwise do, just to provide an enhanced likelihood that the memory controller is ready to service an access request in association with such urgent processing tasks. Indeed the urgency data could also be used at step 245 to determine the power mode to transition to. For example, for urgent requests it may be determined to exit directly to the fully powered mode. Following step 250, transition to the determined power mode is initiated, whereafter the process returns to step 200.

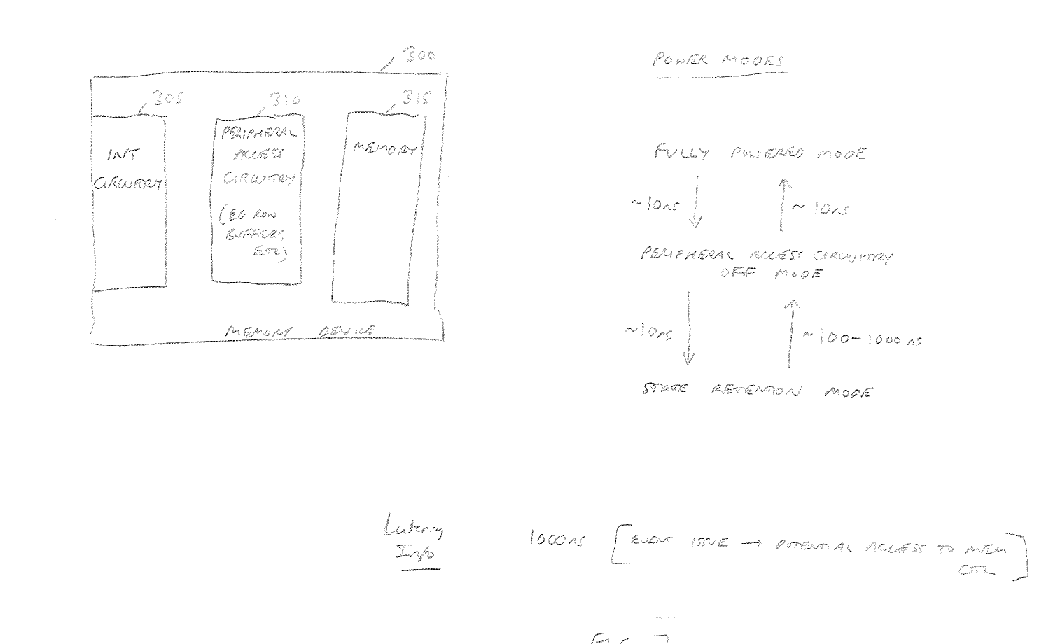

FIG. 7 illustrates various components that can be provided within a memory device, and associated power modes. The memory device 300 includes not only the memory storage components 315 used to store the actual data, but also interface circuitry 305 for interfacing the memory device with the memory controller in order to receive and process the various commands from the memory controller. Further, there will be peripheral access circuitry 310 used to perform the required operations in respect of the memory storage components 315. Whilst the memory device can take a variety of forms, if by way of example a dynamic random access memory (DRAM) is considered, such peripheral access circuitry will include row buffer circuitry used to temporarily store a row of data from an associated bank so that it can be accessed. In particular, in order to access a data value in a row of a bank of DRAM memory, that row first has to be moved into the relevant row buffer via RAS commands issued from the memory controller, such a RAS command also being referred to herein as an activate command. Once the row has been stored in the row buffer, then individual memory addresses within that row can be access via CAS commands issued from the memory controller. Ultimately, when accesses to the row have been completed, or when a new row within the bank needs to be accessed, a precharge command is issued from the memory controller to cause the current contents of the row within the row buffer to be stored back into the associated bank within the DRAM.

In a fully powered mode, all of the components of 305, 310, 315 will be powered. However, there will be a variety of lower power modes that the memory controller can typically place the memory device in. By way of example, a mode may be provided where the peripheral access circuitry is turned off. This provides some power saving benefits. Further, the time taken to enter the peripheral access circuitry off mode from the fully powered mode and to then exit back to the fully powered mode is relatively short, and accordingly the memory device can react fairly quickly to exit the peripheral access circuitry off mode back to the fully powered mode. However, in periods where it is known that the memory device is likely to be unused, the power mode control circuitry 30 may enter the memory device into an even more power efficient mode, such as a state retention mode where the interface circuitry 305 and the peripheral access circuitry 310 are turned off Whilst this can give significant further power consumption benefits, and can be entered into relatively quickly, there is a significant latency involved in exiting that state retention mode. In the particular example given, this may be up to a thousand nanoseconds. This timing information can be stored within the memory controller and used when deciding how to react to the wakeup stimulus signals received.

As mentioned earlier, such information can be combined with latency information about the time expected before a potential access to the memory controller from the processing unit will occur. Purely by way of example, if that latency information indicates that the latency is approximately 1000 nanoseconds, then if the power mode control circuitry determines that the current power mode is the peripheral access circuitry off mode, and it decides that it is appropriate to exit back to the fully powered mode, it may still be able to defer initiation of that process for quite some period of time. However, conversely, if the memory device is currently in the state retention mode, it may decide to trigger initiation of the power mode transition immediately in order to maximise the chances that the memory device will be in a fully operating state by the time any such memory access is received.

FIG. 8 illustrates an alternative embodiment of the memory controller 25. As mentioned earlier, a variety of power mode control inputs are used by the power mode control circuitry 30. One such input may include an indication of activity history from an activity history storage 355 maintained by the memory controller 25 based on indication of activities from the caches and interconnect. For example, such an activity history can be used to identify idle periods of time, and cause power saving entry control circuitry 350 to initiate transitions to more power efficient modes of operation dependent thereon. In one embodiment, an indication of each wakeup stimulus signal can be passed over path 360 to the activity history 355 for adding to the overall activity history, which is then used to determine suitable times for entering the power saving modes. Furthermore, in one embodiment, that history of wakeup stimulus events can be separately maintained, as shown by element 365 within the activity history storage 355, and provided as and when required over path 370 to the power exit control circuitry 110. Returning to the discussion of FIG. 6A, and in particular the optional step 240, the power saving exit control circuitry 110 may reference this wakeup stimulus history 365 in order to decide whether a recent history of wakeup stimulus signals indicates that a transition from the current power mode to a less power saving mode of operation is warranted.

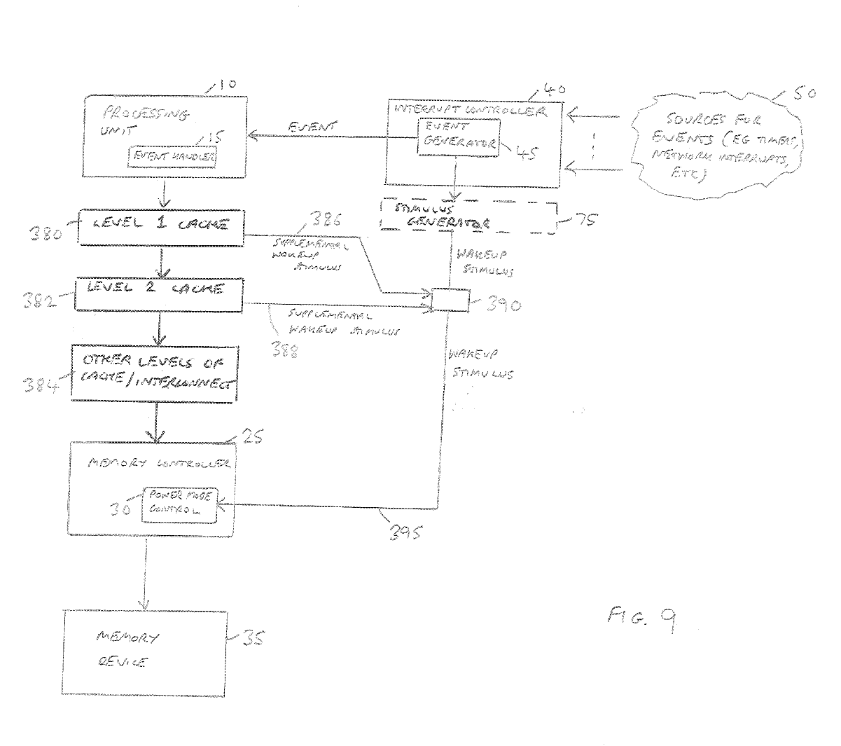

There are a number of scenarios where the reference to such history data could be useful, but FIG. 9 illustrates one particular example embodiment. The embodiment of FIG. 9 is similar to that discussed earlier with reference to FIGS. 1 and 2, with the stimulus generator 75 of FIG. 2 being optionally incorporated within the system. In this embodiment, various levels of cache are shown separately. For example a level 1 cache 380 will be closely coupled to the processing unit 10, but typically there will also be a level 2 cache 382 and optionally one or more other levels of cache and/or an interconnect 384. In one embodiment, in addition to the wakeup stimulus signals generated as a result of events issued by the interrupt controller, one or more of the levels of cache may issue supplemental wakeup stimulus signals. For example, the level one cache may in certain situations generate a supplemental wakeup stimulus signal over path 386, and similarly the level 2 cache may under certain situations generate a supplemental wakeup stimulus signal over path 388. Such supplemental wakeup stimulus signals will be multiplexed into the wakeup stimulus signal path via the element 390.

As an example of a situation where a cache may generate a supplemental wakeup stimulus, consider a situation where the event handler 15 begins to perform a series of processing operations in response to the event from the interrupt controller 40. If at some point an access request is issued to the level one cache 380, and that gives rise to a cache miss, then this may in itself be indicative of an increased likelihood than an access will ultimately be required to the memory device. Accordingly, a supplemental wakeup stimulus signal could be issued, which when considered in combination with the preceding wakeup stimulus signal generated directly as a result of the event being issued from the interrupt controller, may cause the power mode control circuitry 30 to determine that a transition in power mode is warranted, even if it previously decided that such a transition was not warranted based purely on a review of the wakeup stimulus signal issued in response to the event being generated by the interrupt controller. The level 2 cache 382 could operate it in a similar manner, and generate further supplemental wakeup stimulus signals if and when a miss occurs in the level 2 cache.

In a further alternative embodiment, such supplemental wakeup stimulus signals may provide address information indicative of the address that has resulted in a miss in the cache. This can be useful to the power mode control circuitry 30 in situations where there are multiple physical structures within the memory device whose power can be controlled independently. For example, considering the earlier mentioned example of DRAM memory, typically this is constructed as a series of ranks, with each rank consisting of a plurality of banks, and with power control being possible independently in respect of the ranks. Accordingly, based on address information output in the supplemental wakeup stimulus signals, the power mode control circuitry may be able to take independent decisions about the appropriate power mode for each of the ranks, based on how the addresses will be decoded to identify the particular ranks within the memory device which need accessing.

Further, in alternative embodiments there may be multiple memory controllers controlling different memory devices, with each of the memory controllers receiving the wakeup stimulus signals. In such embodiments, such address information as provided in such supplemental wakeup stimulus signals can be used to allow some differentiation in the decisions taken by the different memory controllers, dependent on how each address is mapped to the associated memory devices.

Whilst in the above described embodiments the interrupt controller 40 is shown as a single structure, it will be appreciated that in some systems there may be various hierarchical levels of interrupt controllers. For example, a global interrupt controller may communicate with various local interrupt controllers that themselves communicate with various processing units. In such arrangements, the wakeup stimulus signals may be generated in response to events issued by the local interrupt controllers and/or in response to events issued by the global interrupt controller.

Whilst DRAM memory has been given as an example of the memory device used in the above described embodiments, the use of such embodiments is not restricted to DRAM memory. Indeed, the techniques can be used in association with any memory devices that can be placed in various power saving modes of operation. For example, the techniques can equally be used with Correlated Electron Random Access Memory (CeRAM), Ferroelectric RAM (FeRAM), etc.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

We claim:

1. A system comprising:
a processing device to perform processing operations on data;
a memory controller for a memory device used to store data for access by the processing device, the memory controller having power mode control circuitry to switch the memory device between different power modes of operation; and
an interrupt controller to issue an event signal to the processing device to trigger performance of at least one processing operation;
the interrupt controller further being arranged on issuing the event signal to initiate generation of a wakeup stimulus signal to the power mode control circuitry, the power mode control circuitry being arranged to determine whether to change the power mode of operation of the memory device in dependence on the wakeup stimulus signal.

2. A system as claimed in claim 1, wherein the power mode control circuitry is responsive to the wakeup stimulus signal to transition the memory device from a first power mode of operation to a second power mode of operation, where the second power mode of operation consumes more power than the first mode of operation, in anticipation of the performance of said at least one processing operation by the processing device requiring data to be accessed in said memory device.

3. A system as claimed in claim 1, wherein the interrupt controller generates the wakeup stimulus signal directly from the event signal.

4. A system as claimed in claim 1, further comprising:
stimulus generation circuitry responsive to an indication of issuance of said event signal to generate the wakeup stimulus signal with reference to control data.

5. A system as claimed in claim 4, wherein said control data comprises filter data used to identify for which types of event signal the wakeup stimulus signal is to be generated.

6. A system as claimed in claim 4, wherein said control data comprises hint data to be provided with said wakeup stimulus signal for reference by the power mode control circuitry when determining whether to change the power mode of operation of the memory device in dependence on the wakeup stimulus signal.

7. A system as claimed in claim 6, wherein said hint data comprises at least one of likelihood data indicative of a likelihood that the performance of said at least one processing operation by the processing device will require data to be accessed in said memory device, and urgency data indicating an urgency with which said at least one processing operation needs to be performed by the processing device.

8. A system as claimed in claim 4, further comprising:
control storage to store said control data;
the processing device having access to the control storage in order to write said control data into the control storage.

9. A system as claimed in claim 4, wherein the stimulus generation circuitry is provided within the interrupt controller.

10. A system as claimed in claim 1, wherein the power mode control circuitry is responsive to the wakeup stimulus signal to determine a current power mode of operation of the memory device, and if that current power mode of operation is not the highest power mode of operation, to determine a higher power mode of operation to which the memory device is to be transitioned to in dependence on the wakeup stimulus signal.

11. A system as claimed in claim 10, wherein the power mode control circuitry is arranged to reference power mode transition reference data to determine whether the wakeup stimulus signal warrants the transitioning of the memory device from its current power mode of operation to said higher power mode of operation.

12. A system as claimed in claim 11, wherein said power mode transition reference data comprises energy cost data indicative of the energy consumed in transitioning the memory device from its current power mode of operation to said higher power mode of operation.

13. A system as claimed in claim 10, wherein the power mode control circuitry is arranged to reference power mode transition reference data to determine timing for transition of the memory device from its current power mode of operation to said higher power mode of operation.

14. A system as claimed in claim 13, wherein said power mode transition reference data comprises timing data indicative of the time required to transition the memory device from its current power mode of operation to said higher power mode of operation.

15. A system as claimed in claim 14, wherein the power mode control circuitry is arranged to further reference latency data indicative of a time delay between issuance of said event signal and an access being required to said memory device in response to performance of said at least one processing operation by the processing device.

16. A system as claimed in claim 10, wherein the power mode control circuitry is arranged to reference hint data provided with the wakeup stimulus signal to determine whether the wakeup stimulus signal warrants the transitioning of the memory device from its current power mode of operation to said higher power mode of operation.

17. A system as claimed in claim 16, wherein the power mode control circuitry is arranged to reference a history of wakeup stimulus signals to determine whether a current wakeup stimulus signal warrants the transitioning of the memory device from its current power mode of operation to said higher power mode of operation.

18. A system as claimed in claim 1, wherein the processing device is coupled to the memory controller via a cache hierarchy comprising one or more levels of cache, and at least one level of cache within the cache hierarchy is arranged to issue a supplemental wakeup stimulus signal to the memory controller on occurrence of a predetermined event.

19. A system as claimed in claim 18, wherein said predetermined event comprises a cache miss arising in said at least one level of cache for data required by said at least one processing operation performed by the processing device.

20. An interrupt controller comprising:
event signal generation circuitry to issue an event signal to a processing device to trigger performance of at least one processing operation; and
wakeup stimulus generation circuitry to generate a wakeup stimulus signal to power mode control circuitry of a memory controller on issuance of the event signal, for reference by the power mode control circuitry to determine whether to change the power mode of operation of an associated memory device.

21. A memory controller comprising:
an interface to a memory device used to store data for access by a processing device; and
power mode control circuitry to switch the memory device between different power modes of operation;
the power mode control circuitry being responsive to a wakeup stimulus signal triggered by an interrupt controller's issuance of an event signal to the processing device, to determine whether to change the power mode of operation of the memory device.

22. A method of controlling a power mode of operation of a memory device, comprising:
employing power mode control circuitry, within a memory controller for the memory device, to switch the memory device between different power modes of operation;
issuing an event signal from an interrupt controller to a processing device to trigger performance of at least one processing operation by the processing device;
employing the interrupt controller, on issuing the event signal, to initiate generation of a wakeup stimulus signal to the power mode control circuitry; and
within the power mode control circuitry, determining whether to change the power mode of operation of the memory device in dependence on the wakeup stimulus signal.
